(19) United States
(12) Patent Application Publication
(10) Pub. No.: US 2007/0269774 A1
(43) Pub. Date: Nov. 22, 2007

(54) NOVEL ENHANCED PROCESS FOR OPTIMIZING THERMAL ENERGY BALANCE TO REDUCE BODY MASS IN MAMMALS

(76) Inventor: Ali Djowharzadeh, Laguna Hills, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/735,912

(22) Filed: Apr. 16, 2007

Related U.S. Application Data
(60) Provisional application No. 60/792,168, filed on Apr. 14, 2006.

(51) Int. Cl. G09B 19/00

(52) U.S. Cl. 434/127; 434/235; 604/514; 434/262; 434/367

(57) ABSTRACT

A series of steps for optimizing body mass in mammals includes crafting a regimen relating to the use of ambient temperature or hotter temperatures for ingested food and liquids explaining by way of printed publications, lectures, tutorials and the like the application of the principles to a daily food intake regimen and observing and tailoring the results to optimize body mass. Business methods embodying the same are also taught.

### RELATED APPLICATION

This application claims the benefit of and full Paris Convention priority from U.S. Provisional Application Ser. No. 60/792,163 filled 14 Apr. 2006, which matter likewise expressly incorporated by reference and claimed the priority of U.S. Provisional Application Ser. No. 60/671,824, filed Apr. 15, 2005, the contents of which are incorporated by reference herein in their entirety as if fully set forth herein.

### BACKGROUND

1. Field of the Invention

The present invention relates to body mass regulation in mammals, and healthy-lifestyle based dietary regimens.

The present invention specifically relates to using thermodynamic processes to regulate body mass in mammals.

The present invention likewise includes those materials which were appended to the provisional filings related hereto and expressly incorporated by reference herein as appendices and exhibits which explain in detail the teachings of the instant disclosure. Likewise, expressly incorporated by reference is the book, authored by the present inventor entitled The Hot Diet: The Real Reason You're Gaining Weight . . . and How to Lose It Fast and Forever (Djowharzadeh, and Quinn, Thomas A. Nelson Publishers, 2007).

In summary, a longstanding need for a process and products thereby is addressed by the teachings of the present invention, whereby business methods are likewise disclosed, and related usages of the teachings of the present invention.

### OBJECTS AND SUMMARY OF THE INVENTION

Briefly stated, a series of steps for optimizing body mass in mammals includes crafting a regimen relating to the use of ambient temperature or hotter temperatures for ingested food and liquids, explaining by way of printed publications, lectures, tutorials and the like the application of the principles to a daily food intake regimen and observing and tailoring the results.

According to embodiments of the present invention there is provided a process for optimizing thermodynamics to mitigate generation and maintenance of extraneous body mass in mammals which comprises the steps of managing the temperature of ingested substances and liquids to maintain the same above ambient temperature as possible, optimizing the setting and frequencies of caloric intake sessions, and balancing mechanical agitation, temporal sequence and post-ingestion processing.

According to embodiments of the present invention there is provided a dietary regimen for optimizing thermodynamics mammals, comprising, providing a series of principles relating to the use of ambient temperature or hotter temperatures for ingested food and liquids, explaining the application of the principles to a daily food intake regimen and observing and tailoring the results to optimize body mass.

According to embodiments of the present invention there is provided A business method for promoting thermodynamic body, mass management and promoting health and well-being comprising, crafting a regimen relating to the use of ambient temperature or hotter temperatures for ingested food and liquids, explaining by way of printed publications, lectures, tutorials and the like the application of the principles to a daily food intake regimen, observing and tailoring the results to optimize body mass.

### DETAILED DESCRIPTION OF THE INVENTION

The present inventor has realized a system for improving the health of mammals is based upon the thermodynamics of their food processing systems.

According to the instant teachings business methods, diet processes and products are disclosed which allow mammals to control their body mass by keeping the mean temperature of things ingested within a proper range.

By eliminating ice, and things which lower the temperature of food and drink ingested, the present inventor has contributed to the progress of science and the useful arts enabling significant mass reductions in those following his regimen.

As a result of years of study of dietary cultures and trends in human body mass, the present inventor has realized that lowering of body temperature just prior to, or during eating, has a negative impact on the digestion and subsequent caloric retention of many people. A global series of studies has concluded that in cultures where refrigeration and ice generation abound, higher obesity rates often result. Accordingly, the present inventor has developed a series of recipes and dietary instructions enabling most users to lose weight and keep it off.

The Hot Diet™ developed by the present inventor is based upon principles which relate to and control each aspect of the instant dieting regimen;

1. Star with and maintain a clean container—your digestive tract;

2. Use the best components that can be found;

3. Introduce components at an optimal rate;

4. Use heat to maximize results;

5. Exercise for a better burn;

6. Different pressures yield different results; and,

7. Clean the container thoroughly to start efficiently next time.

The present inventor has discovered that following these principles permits those mammals whose body masses are monitored to be maintained and/or decreased over time. Likewise, current scientific literature supports that life extension and minimum caloric intake are related.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. In a process for optimizing thermodynamics to mitigate generation and maintenance of extraneous body mass in mammals the improvement comprising:
managing the temperature of ingested substances and liquids to maintain the same above ambient temperature as possible;
optimizing the setting and frequencies of caloric intake sessions; and
balancing mechanical agitation temporal sequence and post-ingestion processing, including exercise to manage optimized weight.

2. The process of claim 1, whereby pre-ingestion activities include stating with an maintaining an unencumbered digestive tact.

3. The process of claim 2, further comprising selection of ingested substances and liquids from sources that present them in a fresh state.

4. The process of claim 3, further comprising a series of inactive periods prior to ingestion, and during and after ingestion, whereby complete mastication and processing occurs for anything ingested.

5. The process of claim 4, whereby ingested substances and liquids are heated before ingesting.

6. The process of claim 5 in combination with exercise.

7. The process of claim 6, wherein a relaxed setting is used.

8. A dietary regimen for optimizing thermodynamics in mammals according to claim 7, which comprises:
providing a series of principles relating to the use of at least one of ambient temperature and hotter temperatures for ingested food and liquids;
explaining the application of the principles to a daily food intake regimen;
observing and tailoring the results to optimize body mass.

9. The regimen of claim 8, presented in at least one format selected from the group consisting of literature computer generated output, audio data, video data and verbal expression in at least one of real-time and recorded.

10. A business method for promoting thermodynamic body mass management and promoting health and well-being comprising:
crafting a regimen relating to the use of at least one of ambient temperature and hotter temperatures for ingested food and liquids;
explaining by way of printed publications, lectures: tutorials and the like the application of the principles to a daily food intake regimen; and
observing and tailoring the results to optimize body mass.

11. A kit for promoting a HOT DIET™ type of dietary regimen comprising, in combination:
at least a set of educational and instructional materials; and
directions on how to follow the dietary regimen.
